(19) United States
(12) Patent Application Publication
(10) Pub. No.: US 2006/0237255 A1
(43) Pub. Date: Oct. 26, 2006

(54) Vehicle collision sensing system

(75) Inventors: Shingo Wanami, Kariya-city (JP); Seiya Ide, Okazaki-city (JP); Satoru Takehara, Obu-city (JP)

Correspondence Address: HARNESS, DICKEY & PIERCE, P.L.C., P.O. BOX 828, BLOOMFIELD HILLS, MI, 48303, US

(73) Assignee: DENSO Corporation, Kariya-city (JP)

(21) Appl. No.: 11/410,842

(22) Filed: Apr. 25, 2006

(30) Foreign Application Priority Data
Apr. 26, 2005 (JP) 2005-128257

(51) Int. Cl. B60K 28/10

(52) U.S. Cl. 180/274

(57) ABSTRACT

A window glass is displaceably supported by a vehicle door and is receivable in an interior space, which is formed between an inner panel and an outer panel of the door. A pressure sensor, which senses a pressure in the interior space, is positioned on an inner panel side of the window glass in a state where the window glass is received in the interior space. A collision of a vehicle is sensed based on a measured pressure of the pressure sensor.

### CROSS REFERENCE TO RELATED APPLICATION

This application is based on and incorporates herein by reference Japanese Patent Application No. 2005-128257 filed on Apr. 26, 2005. This application is also related to U.S. application Ser. No. ______, entitled “VEHICLE COLLISION SENSING SYSTEM,” filed on Apr. 25, 2006.

### BACKGROUND OF THE INVENTION

1. Field of the Invention

The present invention relates to a vehicle collision sensing system, which senses, for example, a pressure in an interior space of a door of a vehicle and determines collision of the vehicle based on the sensed pressure.

2. Description of Related Art

One previously proposed way of activating an occupant protective device is use of a pressure sensor, which serves as a collision sensing means for sensing a collision of the vehicle (see, for example, Japanese Unexamined Patent Publication No. H02-249740). For example, Japanese Unexamined Patent Publication No. H02-249740 recites a system that includes an airtight air tank, which is arranged in an interior space of a door of a vehicle, and a pressure sensor, which senses a pressure in the air tank. In this system, when the pressure in the air tank sensed by the pressure sensor becomes equal to or greater than a predetermined threshold value, it is determined that a collision of the vehicle has occurred, and a protective device, such as an air bag, is activated.

However, a receiving space for receiving the air tank in the interior space of the vehicle door needs to be provided. Therefore, the limitations on the designing of the vehicle door and the air tank are increased. Furthermore, the provision of the air tank leads to an increase in the manufacturing costs. In view of the above points, it is conceivable to eliminate the air tank and directly measure the pressure in the interior space of the vehicle door with the pressure sensor to sense the collision of the vehicle. That is, the collision may be determined by comparing the pressure in the interior space of the vehicle door with the predetermined threshold value.

The window glass is received in the interior space of the door of the vehicle. A pressure transmission path in the interior space of the door of the vehicle changes depending on a degree of opening of the window glass, i.e., a state of reception of the window glass in the interior space of the vehicle door. That is, at the time of collision of the vehicle, an amount of change in the pressure at a location where the pressure sensor is positioned varies depending on the state of reception of the window glass in the vehicle door. Therefore, in the case where the collision of the vehicle is determined by comparing the pressure in the interior space of the vehicle door with the predetermined threshold value, there is a possibility that the collision of the vehicle cannot be reliably sensed.

### SUMMARY OF THE INVENTION

The present invention is made in view of the above points. Thus, it is an objective of the present invention to provide a vehicle collision sensing system, which enables more reliable sensing of a collision of a vehicle regardless of a state of reception of a window glass in an interior space of a vehicle door.

To achieve the objective of the present invention, there is provided a vehicle collision sensing system for sensing a collision of a vehicle. The vehicle collision sensing system includes a vehicle door, a plate member, a pressure sensing means, a received amount sensing means and a collision determining means. The vehicle door includes an outer panel and an inner panel. The outer panel faces an outside of the vehicle. The inner panel is placed on a passenger compartment side of the outer panel and forms a predetermined space between the outer panel and the inner panel. The plate member is displaceably supported by the vehicle door and is receivable in the predetermined space. The pressure sensing means is for sensing a pressure in the predetermined space. The pressure sensing means is positioned on an inner panel side of the plate member in a state where the plate member is received in the predetermined space. The received amount sensing means is for sensing a received amount of the plate member in the predetermined space. The collision determining means is for determining the collision of the vehicle based on the pressure, which is sensed by the pressure sensing means, and the received amount of the plate member, which is sensed by the received amount sensing means.

### BRIEF DESCRIPTION OF THE DRAWINGS

The invention, together with additional objectives, features and advantages thereof, will be best understood from the following description, the appended claims and the accompanying drawings in which:

FIG. 1 is a block diagram showing a vehicle collision sensing system according to a first embodiment of the present invention;

FIG. 2A is a cross sectional view schematically showing an entire structure of a vehicle door in a closed state of a window glass of the door according to the first embodiment;

FIG. 2B is an enlarged view of a circled portion IIB in FIG. 2A;

FIG. 3 is a diagram for describing a support structure of the window glass and an arrangement of a window glass position sensor according to the first embodiment;

FIG. 4A is a cross sectional view schematically showing the entire structure of the door of the vehicle in an opened state of the window glass of the door;

FIG. 4B is an enlarged view of a circled portion IVB in FIG. 4A;

FIG. 5 is a diagram for describing collision determination of the vehicle in a comparator of an air bag ECU and indicating a third signal relative to an elapsed time since collision of the vehicle;

FIG. 6 is a block diagram showing a vehicle collision sensing system according to a second embodiment of the present invention; and

FIG. 7 is a diagram for describing a signal processing operation in a pressure sensor and indicating a voltage of a fourth signal and a voltage of a fifth signal relative to the elapsed time since the collision of the vehicle.

### DETAILED DESCRIPTION OF THE INVENTION

Next, embodiments of the present invention will be described with reference to the accompanying drawings.

### FIRST EMBODIMENT

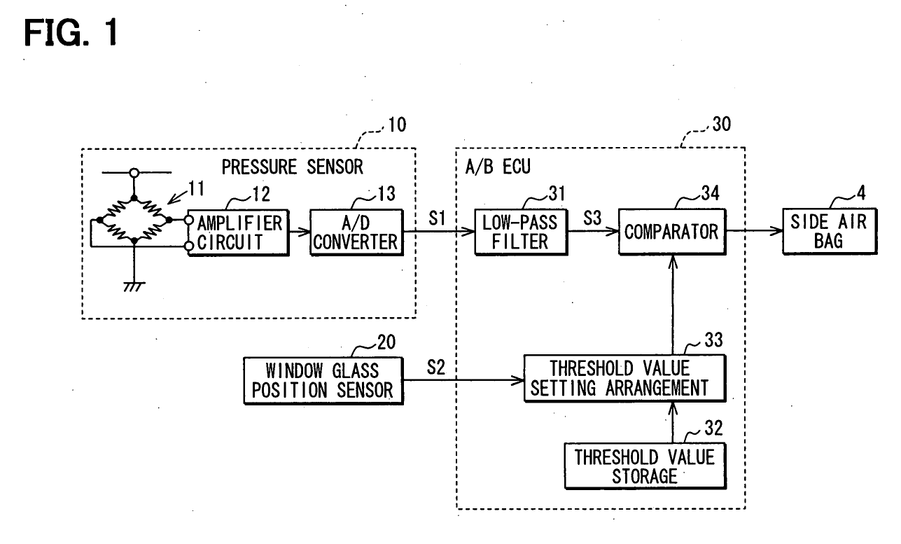

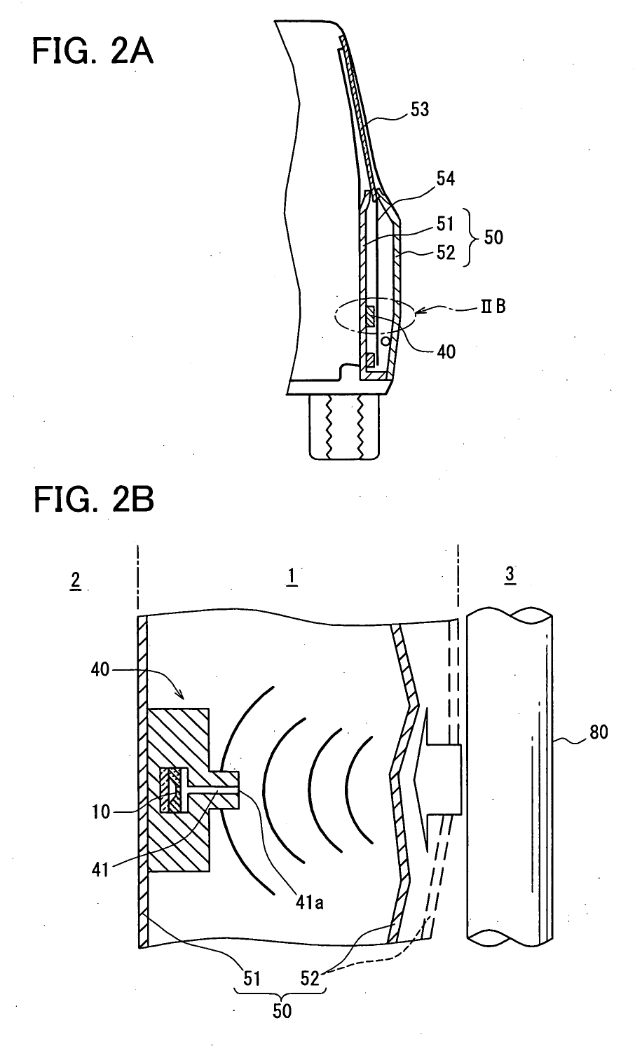

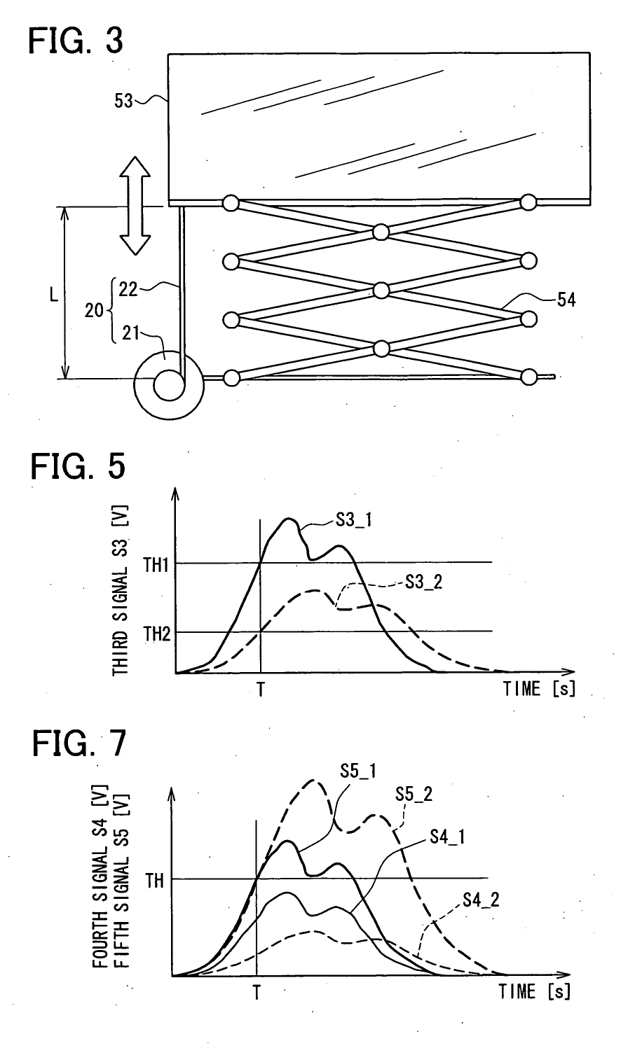

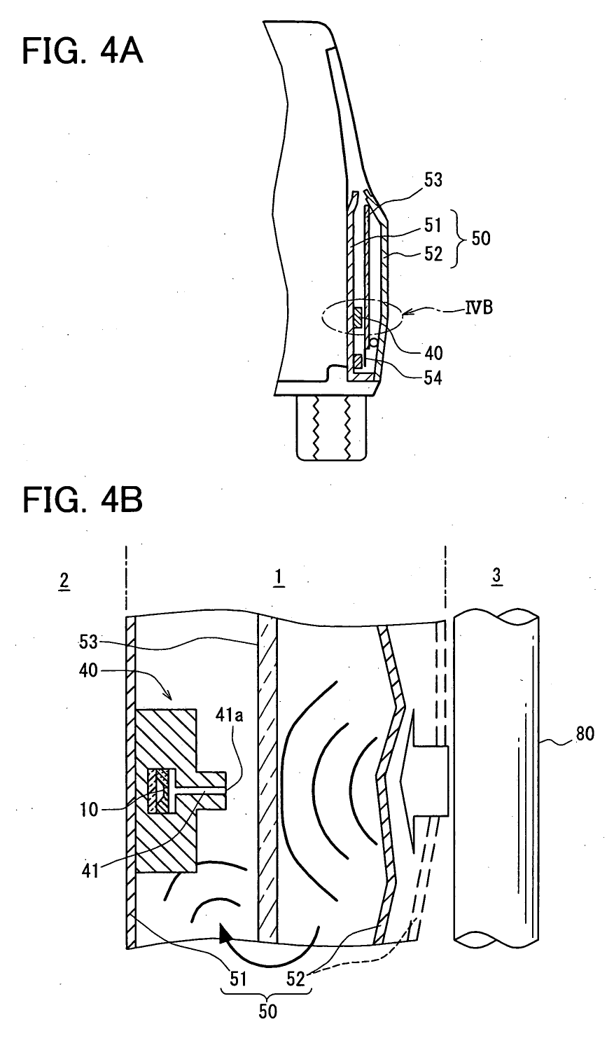

A vehicle collision sensing system according to a first embodiment of the present invention will be described with reference to FIGS. 1 to 5. FIG. 1 is a block diagram showing the vehicle collision sensing system of the first embodiment. FIGS. 2A and 2B show cross sectional views of a vehicle door 50 in a state where a window glass 53 is raised to place the window glass 53 in a closed position, at which a window opening of the vehicle door 50 is closed by the window glass 53. Specifically, FIG. 2A is a cross sectional view of the vehicle door 50 in the state where the window glass 53 is in the closed position. FIG. 2B is a partial enlarged view of a circled portion IIB in FIG. 2A. FIG. 3 is a diagram for describing a support structure of the window glass 53 and a structure of a window glass position sensor 20. FIGS. 4A and 4B show cross sectional views of the vehicle door 50 in a state where the window glass 53 is lowered to place the window glass 53 in an opened position, at which the window opening of the vehicle door 50 is opened. Specifically, FIG. 4A is a cross sectional view of the vehicle door 50 in the state where the window glass 53 is in the opened position. FIG. 4B is a partial enlarged view of a circled portion IVB in FIG. 4A. FIG. 5 is a diagram for describing collision determination of the vehicle, which is carried out by a comparator 34 of an air bag ECU 30.

As shown in FIG. 1, the vehicle collision sensing system of the first embodiment includes a pressure sensor 10, the window glass position sensor 20 and the air bag ECU (hereinafter, referred to as an A/B ECU) 30.

The pressure sensor (a pressure sensing means) 10 is a sensor that senses a pressure in a door interior space 1, which is formed in an interior of the vehicle door 50. The location of the pressure sensor 10 will be described with reference to FIGS. 2A and 2B. The pressure sensor 10 is provided in a sensor module 40. As shown in FIGS. 2A and 2B, the sensor module 40 is arranged in the door interior space 1. Specifically, the sensor module 40 is arranged in the door interior space 1, which is formed between an inner panel 51 and an outer panel 52 that constitute the vehicle door 50. Further specifically, the sensor module 40 is arranged to an outer panel 52 side surface of the inner panel 51. Also, in the closed state of the window glass 53, the sensor module 40 is placed on a passenger compartment 2 side of the window glass 53 (FIGS. 4A and 4B).

As shown in FIG. 2B, the sensor module 40 receives the pressure sensor 10 and has a sensing hole 41. The sensing hole 41 communicates between the pressure sensor 10 and a sensing opening 41a, which opens to the door interior space 1. That is, the pressure sensor 10 receives the pressure of the door interior space 1 from the sensing opening 41a through the sensing hole 41.

Here, a structure of the vehicle door 50 and the window glass 53 will be briefly described with reference to FIGS. 2A to 4B. The vehicle door 50 includes the inner panel 51 and the outer panel 52. The inner panel 51 is a panel that partitions between the door interior space 1 and a vehicle passenger compartment 2. The outer panel 52 is a panel that partitions between the door interior space 1 and a space at an outside 3 of the vehicle.

When a side collision impact is laterally applied in a direction of an arrow in FIGS. 2B and 4B from an external obstacle (e.g., a utility pole) 80 located at the outside 3 of the vehicle to the outer panel 52, the outer panel 52 is deformed (see a change from a dotted line before the collision to a solid line after the collision in FIGS. 2B and 4B). Due to the deformation of the outer panel 52 caused by the application of the side collision impact, the door interior space 1 is also deformed.

The door interior space 1 can accommodate, i.e., receive the window glass (plate member) 53. As shown in FIGS. 2A and 3, the window glass 53 is supported by the inner panel 51 through a link member 54. When the link member 54 is driven by, for example, a motor, the window glass 53 is moved in a vertical direction (upward or downward) in FIGS. 2A and 3. FIG. 4A shows the state where the entire window glass 53 is received in the door interior space 1. Here, as shown in FIG. 4A, in the state where the window glass 53 is received in the door interior space 1, the pressure sensor 10 is placed between the window glass 53 and the inner panel 51.

Now, the description will be made with reference to FIG. 1. As shown in FIG. 1, the pressure sensor 10, which is arranged in the manner described above, includes a pressure sensor chip (a sensing circuit) 11, an amplifier circuit 12 and an A/D converter 13. The pressure sensor chip 11 includes diffused resistors, which form a Wheatstone bridge on a diaphragm that is produced by thinly processing a center portion of a silicon chip. When the pressure is applied to the pressure sensor chip 11 to cause deformation of the diaphragm, an electric potential difference between a left end and a right end of the pressure sensor chip 11 in FIG. 1 changes. Then, the pressure sensor chip 11 outputs a signal, which indicates the electric potential difference between the left end and the right end of the pressure sensor chip 11 in FIG. 1. One side of the diaphragm of the pressure sensor chip 11 is communicated with the door interior space 1, and the other side of the diaphragm of the pressure sensor chip 11 forms a vacuum space between the other side of the diaphragm and a glass pedestal. That is, the diaphragm of the pressure sensor chip 11 is deformed according to the pressure of the door interior space 1, which is applied through the sensing opening 41a. In other words, the electric potential difference between the left end and the right end of the pressure sensor chip 11 in FIG. 1 corresponds to the pressure in the door interior space 1.

The amplifier circuit 12 amplifies the signal, which is outputted from the pressure sensor chip 11 and indicates the electric potential difference. Then, the signal, which is amplified by the amplifier circuit 12, undergoes analog to digital conversion through the A/D converter 13. Thereafter, the A/D converter 13 outputs a voltage signal (a first signal) S1, which is A/D converted, to the A/B ECU 30.

The window glass position sensor (a received amount sensing means) 20 is a sensor that senses the vertical position of the window glass 53 relative to the vehicle door 50. The window glass position sensor 20 may be, for example, a stroke sensor. As shown in FIG. 3, the window glass position sensor 20 of the present embodiment includes a sensor main body 21 and a cable 22. The sensor main body 21 is fixed to the inner panel 51 at a height that is generally the same as a lower end of the link member 54. Furthermore, the sensor main body 21 can wind, i.e., receive the cable 22. One end of the cable 22 is connected to a lower end of the window glass 53. A received length of the cable 22, which is received in the sensor main body 21, changes according to the received amount of the window glass 53 in the door interior space 1. The sensor main body 21 can compute the received length of the cable 22, which is wound around, i.e., is received in the sensor main body 21. That is, the window glass position sensor 20 can compute a distance L from the fixed point of the sensor main body 21 to the lower end of the window glass 53. The distance L between the fixed point of the sensor main body 21 to the lower end of the window glass 53 corresponds to the vertical position of the window glass 53 relative to the vehicle door 50, that is, the received mount of the window glass 53 in the door interior space 1. The window glass position sensor 20 outputs a voltage signal (a second signal) S2, which corresponds to the received amount of the window glass 53 in the door interior space 1, to the A/B ECU 30. That is, as the received amount of the window glass 53 in the door interior space 1 is increased, the voltage value of the second signal S2 is increased. Also, as the received amount of the window glass 53 in the door interior space 1 is reduced, the voltage value of the second signal S2 is reduced.

The A/B ECU 30 determines whether a side air bag 4 should be deployed based on the signals S1, S2 supplied from the pressure sensor 10 and the window glass position sensor 20. The A/B ECU 30 includes a low-pass filter 31, a threshold value storage 32, a threshold value setting arrangement 33 and a comparator 34.

The low-pass filter 31 performs low-pass filtering of the first signal S1 of the pressure sensor 10 at a predetermined cutoff frequency to generate a third signal S3. The predetermined cutoff frequency is set to be higher than the frequency of the pressure of the door interior space 1, which changes at the time of the vehicle collision. The predetermined cutoff frequency is set to be lower than the frequencies of high frequency noises to remove the high frequency noises.

The threshold value storage 32 stores a plurality of threshold values TH, which are used to determine the collision of the vehicle. A corresponding one of the threshold values TH serves as a reference value that is compared with the third signal S3, which is generated by the low-pass filter 31, to determine the collisions of the vehicle. The threshold value storage 32 stores a threshold value map, which includes the threshold values TH that are correlated to the voltage value of the second signal S2, which is supplied from the window glass position sensor 20. Specifically, a full possible voltage range of the second signal S2 (the full possible voltage range of the second signal S2 corresponding to a full possible range of received amount of the window glass 53 in the door interior space 1) is divided into a plurality of voltage sub-ranges. Each of the voltage sub-ranges is associated with a corresponding one of the threshold values TH. For example, one of the threshold values TH, which is associated with the voltage sub-range L1 to L2 of the second signal S2, is set to be TH1, and a next one of the threshold values TH, which is associated with the voltage sub-range L2 to L3 of the second signal S2 is set to be TH2, and so on.

The threshold value setting arrangement (a collision determining means) 33 modifies and sets the threshold value TH used in the collision determination of the vehicle based on the second signal S2 supplied form the window glass position sensor 20 and the threshold value map stored in the threshold value storage 32. Specifically, the threshold value setting arrangement 33 selects the corresponding threshold value TH, which corresponds to the voltage range that covers the second signal S2, from the threshold value map and modifies and sets it as the threshold value TH used in the collision determination of the vehicle.

The comparator (the collision determining means) 34 compares the third signal S3 generated by the low-pass filter 31 with the threshold value TH set by the threshold value setting arrangement 33. When it is determined that the third signal S3 exceeds the threshold value TH, it is determined that a collision of the vehicle has occurred. When it is determined that the collision of the vehicle has occurred, the comparator 34 outputs a signal for deploying the side air bag 4.

The collision determination of the vehicle in the comparator 34 will be described with reference to FIG. 5. FIG. 5 is a diagram showing the voltage value of the third signal S3 (corresponding to the pressure in the door interior space 1) relative to the elapsed time since the collision of the vehicle. In FIG. 5, a solid line S3_1 and a dotted line S3_2 indicate a change in the third signal S3 for two different received amounts of the window glass 53 in the door interior space 1 at the time of applying the same impact to the vehicle. Specifically, the solid line S3_1 indicates a case where the received amount of the window glass 53 in the door interior space 1 is relatively small. The dotted line S3_2 indicates a case where the received amount of the window glass 53 in the door interior space 1 is relatively large.

The behavior of the third signal S3, which vary depending on the received amount of the window glass 53 in the door interior space 1, will be described more specifically with reference to FIGS. 2B, 4B and 5. First, with reference to FIGS. 2B and 5, there will be described the case where the received amount of the window glass 53 in the door interior space 1 is relatively small. When the collision of the vehicle occurs, the outer panel 52 is deformed, and thereby the pressure in the door interior space 1 rises rapidly near the outer panel 52. In the case where the received amount of the window glass 53 in the door interior space 1 is relatively small, the window glass 53 does not exist between the pressure sensor 10 and the outer panel 52. Thus, as shown in FIG. 2B, the pressure change in the door interior space 1 near the outer panel 52 is directly (linearly) transmitted to the pressure sensor 10. At this time, the behavior of the third signal S3 will be similar to the one indicated by the solid line S3_1 in FIG. 5.

Next, with reference to FIGS. 4B and 5, there will be described the case where the received amount of the window glass 53 in the door interior space 1 is relatively large. When the collision of the vehicle occurs, the pressure in the door interior space 1 rises rapidly near the outer panel 52 like in the case described above. In the present case where the received amount of the window glass 53 is relatively large, the window glass 53 exists between the pressure sensor 10 and the outer panel 52, as shown in FIG. 4B. Thus, as shown in FIG. 4B, the pressure change in the door interior space 1 near the outer panel 52 is not directly (linearly) transmitted to the pressure sensor 10. Rather, the pressure bypasses the window glass 53 through a peripheral space around the window glass 53 and is then transmitted to the pressure sensor 10. At this time, the behavior of the third signal S3 will be similar to the one indicated by the dotted line S3_2 in FIG. 5.

That is, the line S3_2, which indicates the third signal S3 in the case of the relatively large received amount of the window glass 53 in the door interior space 1, shows the smaller maximum peak value and a response delay in comparison to the line S3_1, which indicates the third signal S3 in the case of the relatively small received amount of the window glass 53 in the door interior space 1. Here, the response delay is largely due to the increased transmission pass for transmitting the pressure change. Furthermore, the smaller maximum peak value is largely due to the increased transmission pass for transmitting the pressure change and also the fact that door interior space 1 is normally not airtight.

The threshold value map in the threshold value storage 32 stores the threshold values TH that are associated with the voltage values of the second signal S2, each of which corresponds to the received amount of the window glass 53 in the door interior space 1. For example, in the case of the relatively small voltage value of the second signal S2, i.e., in the case of the relatively small received amount of the window glass 53 in the door interior space 1, the threshold value TH would be TH1. Furthermore, in the case of the relatively large voltage value of the second signal S2, i.e., in the case of the relatively large received amount of the window glass 53 in the door interior space 1, the threshold value TH would be TH2, and so on.

That is, in the case of the relatively small received amount of the window glass 53 in the door interior space 1, the threshold value TH1 is set as the threshold value TH in the threshold value setting arrangement 33. When the comparator 34 compares the third signal S3_1 with the threshold value TH1 and determines that the third signal S3_1 exceeds the threshold value TH1, it is determined that a collision of the vehicle has occurred. In contrast, when the comparator 34 determines that the third signal S3_1 does not exceed the threshold value TH1, it is determined that the collision of the vehicle has not occurred. Here, in the case of FIG. 5, the comparator 34 determines, i.e., senses the collision of the vehicle when the elapsed time since the collision of the vehicle reaches time T.

Furthermore, in the case of the relatively large received amount of the window glass 53 in the door interior space 1, the threshold value TH2 is set as the threshold value TH in the threshold value setting arrangement 33. Next, when the comparator 34 compares the third signal S3_2 with the threshold value TH2 and determines that the third signal S3_2 exceeds the threshold value TH2, it is determined that a collision of the vehicle has occurred. In contrast, when the comparator 34 determines that the third signal S3_2 does not exceed the threshold value TH2, it is determined that the collision of the vehicle has not occurred. Here, in the case of FIG. 5, the comparator 34 determines, i.e., senses the collision of the vehicle when the elapsed time measured from the collision of the vehicle reaches time T.

As discussed above, even when the received amount of the window glass 53 in the door interior space 1 varies from one to another, the collision of the vehicle can be reliably sensed by appropriately modifying and setting the threshold value TH based on the received amount of the window glass 53 in the door interior space 1. Furthermore, even when the received amount of the window glass 53 in the door interior space 1 changes from one to another, the collision of the vehicle can be sensed upon elapse of the generally same time period since the collision of the vehicle by appropriately setting the threshold value as long as the same impact is applied to the vehicle.

### SECOND EMBODIMENT

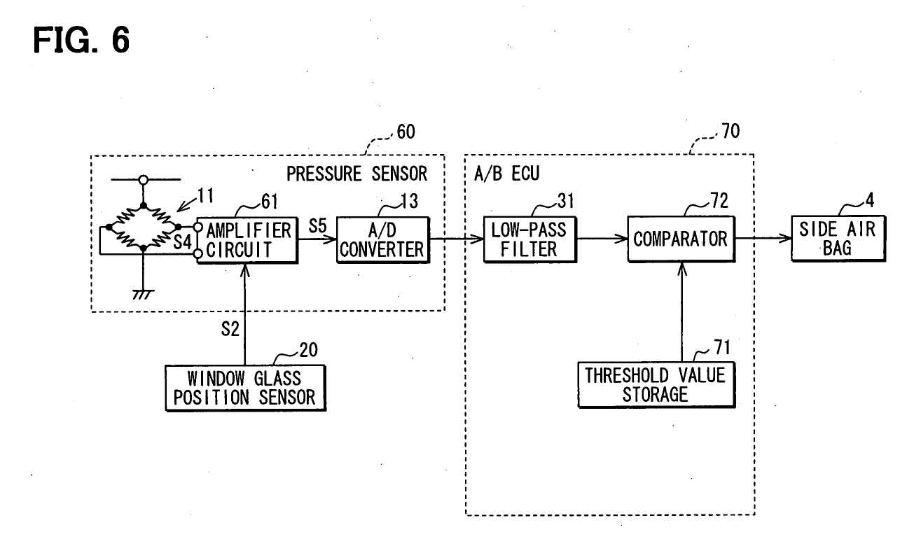

Next, a vehicle collision sensing system according to a second embodiment of the present invention will be described with reference to FIGS. 6 and 7. FIG. 6 is a block diagram showing the vehicle collision sensing system of the second embodiment. FIG. 7 is a diagram for describing a signal processing operation in a pressure sensor 60. In the second embodiment, components similar to those described in the first embodiment will be indicated by the same numerals and will not be described further.

As shown in FIG. 6, the vehicle collision sensing system of the second embodiment includes the pressure sensor 60, the window glass position sensor 20 and an A/B ECU 70. Similar to the pressure sensor 10 of the first embodiment, the pressure sensor 60 is received in the sensor module 40 and is provided to the outer panel 52 side of the inner panel 51.

The pressure sensor 60 includes the pressure sensor chip 11, an amplifier circuit 61 and the A/D converter 13.

The pressure sensor chip 11 is similar to the pressure sensor chip 11 of the first embodiment. That is, the pressure sensor chip 11 includes diffused resistors, which form a Wheatstone bridge on a diaphragm that is produced by thinly processing a center portion of a silicon chip. The pressure sensor chip 11 outputs a signal (a fourth signal) S4, which indicates the electric potential difference between the left end and the right end of the pressure sensor chip 11 in FIG. 6 corresponding to the pressure in the door interior space 1.

The amplifier circuit 61 receives the fourth signal S4, which is outputted from the pressure sensor chip 11 and indicates the electric potential difference. Furthermore, the amplifier circuit 61 also receives the second signal S2, which is outputted from the window glass position sensor 20. The amplifier circuit 61 amplifies the fourth signal S4 in view of the second signal S2 and thereby generates a fifth signal S5. Specifically, in the amplifier circuit 61, as the voltage value of the second signal S2 gets smaller, a degree of amplification becomes smaller. In contrast, as the voltage value of the second signal S2 gets larger, the degree of amplification becomes larger. That is, as the received amount of the window glass 53 in the door interior space 1 is reduced, the degree of amplification is decreased. Also, as the received amount of the window glass 53 in the door interior space 1 is increased, the degree of amplification is increased. The fifth signal S5, which is amplified by the amplifier circuit 61, is A/D converted by the A/D converter 13 and is then supplied to the A/B ECU 70.

The amplification by the amplifier circuit 61 of the pressure sensor 60 will be described with reference to FIG. 7. FIG. 7 is a diagram showing the voltage of the fourth signal S4 and the voltage of the fifth signal S5 relative to the elapsed time since the collision of the vehicle. In FIG. 7, a solid fine line S4_1 and a dotted fine line S4_2 indicate a change in the fourth signal S4 for two different received amounts of the window glass 53 in the door interior space 1 at the time of applying the same impact to the vehicle. Specifically, the solid fine line S4_1 indicates a case where the received amount of the window glass 53 in the door interior space 1 is relatively small. The dotted fine line S4_2 indicates a case where the received amount of the window glass 53 in the door interior space 1 is relatively large. Furthermore, a solid bold line S5_1 indicates a change in the fifth signal S5, which is obtained by amplifying the fourth signal S4_1. Also, a dotted bold line 55_2 indicates a change in the fifth signal S5, which is obtained by amplifying the fourth signal S4_2.

Here, the fourth signals S4_1 and S4_2 change according to the received amount of the window glass 53 in the door interior space 1 in the manner shown in FIG. 7 because of the same reasons as ones discussed with reference to FIG. 5 of the first embodiment. More specifically, when the received amount of the window glass 53 in the door interior space 1 changes, the pressure transmission path from the point near the outer panel 52 to the pressure sensor 10 changes, as discussed above, so that the fourth signals S4_1 and S4_2 change in the manner shown in FIG. 7.

In the case where the same collision impact is applied to the vehicle, the fifth signals S5_1 and S5_2, which are obtained by amplifying the corresponding fourth signals S4_1 and S4_2, will have the characteristic behaviors shown in FIG. 7. That is, the degree of amplification of the fifth signal S5_2, which is obtained at the relatively large received amount of the window glass 53 in the door interior space, is significantly increased relative to the fifth signal S5_1, which is obtained at the relatively small received amount of the window glass 53 in the door interior space 1. Furthermore, the degree of amplification in the amplifier circuit 61 is modified and is set in such a manner that each of the fifth signals S5_1 and S5_2 reaches the threshold value TH at the time T elapsed since the collision of the vehicle.

Now, the description will be made with reference to FIG. 6 once again. The A/B ECU 70 determines whether the side air bag 4 should be deployed based on the signal received from the pressure sensor 60. The A/B ECU 70 includes the low-pass filter 31, a threshold value storage 71 and a comparator 72.

The low-pass filter 31 performs low-pass filtering of the signal received from the pressure sensor 60 at a predetermined cutoff frequency. The predetermined cutoff frequency is set to be higher than the frequency of the pressure of the door interior space 1, which changes at the time of the vehicle collision. The predetermined cutoff frequency is set to be lower than the frequencies of high frequency noises to remove the high frequency noises.

The threshold value storage 71 stores a threshold value TH, which is used to determine the collisions of the vehicle. The threshold value TH serves as a reference value that is compared with the signal, which is generated by the low-pass filter 31, to determine the collisions of the vehicle.

The comparator (the collision determining means) 72 compares the signal, which is generated by the low-pass filter 31, with the threshold value TH, which is stored in the threshold value storage 71. When it is determined that the signal, which is generated by the low-pass filter 31, exceeds the threshold value TH, it is determined that a collision of the vehicle has occurred. When it is determined that the collision of the vehicle has occurred, the comparator 72 outputs a signal for deploying the side air bag 4.

Here, in the comparator 72, the signal, which is generated by the low-pass filter 31, is compared with the threshold value TH to determine the collision of the vehicle. As discussed above, the degree of amplification of the amplifier circuit 61 is modified and set in such a manner the fifth signal S5 reaches the threshold value TH upon elapsed of the time T measured from the collision of the vehicle even when the received amount of the window glass 53 in the door interior space 1 changes as long as the same collision impact is applied to the vehicle. For example, in FIG. 7, the collision of the vehicle is sensed by the comparator 72 when the time T is elapsed since the collision of the vehicle regardless of the received amount of the window glass 53 in the door interior space 1.

As discussed above, even when the received amount of the window glass 53 in the door interior space 1 varies from one to another, the collision of the vehicle can be reliably sensed by appropriately modifying and setting the degree of amplification of the amplifier circuit 61 based on the received amount of the window glass 53 in the door interior space 1. Furthermore, even when the received amount of the window glass 53 in the door interior space 1 changes from one to another, the collision of the vehicle can be sensed upon elapse of the generally same time period since the collision of the vehicle by appropriately setting the degree of amplification as long as the same impact is applied to the vehicle.

Now, modifications of the above embodiments will be described.

In the first embodiment, the theshold value map is stored in the threshold value storage 32, and the corresponding threshold value TH is selected by the threshold value setting arrangement 33. However, the present invention is not limited to this. For example, the threshold value storage 32 and the threshold value setting arrangement 33 may be replaced with a threshold value computing arrangement. For example, the threshold value computing arrangement may compute the threshold value TH based on a corresponding relational expression, which changes the threshold value TH proportional to the signal received from the window glass position sensor 20.

Additional advantages and modifications will readily occur to those skilled in the art. The invention in its broader terms is therefore not limited to the specific details, representative apparatus, and illustrative examples shown and described.

What is claimed is:

1. A vehicle collision sensing system for sensing a collision of a vehicle, comprising:
a vehicle door that includes:
an outer panel that faces an outside of the vehicle; and
an inner panel that is placed on a passenger compartment side of the outer panel and forms a predetermined space between the outer panel and the inner panel;
a plate member that is displaceably supported by the vehicle door and is receivable in the predetermined space;
a pressure sensing means for sensing a pressure in the predetermined space, wherein the pressure sensing means is positioned on an inner panel side of the plate member in a state where the plate member is received in the predetermined space;
a received amount sensing means for sensing a received amount of the plate member in the predetermined space; and
a collision determining means for determining the collision of the vehicle based on the pressure, which is sensed by the pressure sensing means, and the received amount of the plate member, which is sensed by the received amount sensing means.

2. The vehicle collision sensing system according to claim 1, wherein the collision determining means includes:
a comparing means for comparing the pressure, which is sensed by the pressure sensing means, with a predetermined threshold value to determine the collision; and
a threshold value setting means for changing and setting the threshold value based on the received amount of the plate member, which is sensed by the received amount sensing means.

3. The vehicle collision sensing system according to claim 1, wherein:
the pressure sensing means includes:
a sensing circuit that outputs a first signal based the pressure in the predetermined space; and
an amplifier circuit that generates a second signal, which is generated by amplifying the first signal at a predetermined degree of amplification, wherein the amplifier circuit changes the predetermined degree of amplification based on the received amount of the plate member, which is sensed by the received amount sensing means; and
the collision determining means determines the collision of the vehicle based on the second signal.
